(19) United States
(12) Patent Application Publication
(10) Pub. No.: US 2017/0004301 A1
(43) Pub. Date: Jan. 5, 2017

(54) DEVICE MATCHING VERIFICATION METHOD AND THE COMPUTER SYSTEM THEREOF

(71) Applicant: Acer Incorporated, New Taipei City (TW)

(72) Inventors: Hsun-Yao HSU, New Taipei City (TW); Chen-Yi HUANG, New Taipei City (TW); Wen Ta HSIEH, New Taipei City (TW); Chin-Yeh LU, New Taipei City (TW); Shao-Cheng LU, New Taipei City (TW); Chi-Hsiu KAO, New Taipei City (TW); Chung-Ying WU, New Taipei City (TW); Kuan-Yu CHEN, New Taipei City (TW); Kai-Chieh HSU, New Taipei City (TW)

(21) Appl. No.: 15/167,833

(22) Filed: May 27, 2016

Related U.S. Application Data
(63) Continuation-in-part of application No. 14/755,309, filed on Jun. 30, 2015, now abandoned.

(30) Foreign Application Priority Data
Dec. 17, 2015 (TW) 104142427

(51) Int. Cl. G06F 21/44; G06F 21/85

(52) U.S. Cl. CPC G06F 21/44; G06F 21/85

(57) ABSTRACT

A device matching verification method is provided. The device matching verification method includes reading, respectively, first color code information stored in a cradle device and second color code information stored in a memory device of an electronic device; transforming the first color code information to display a first color code on a first display region of a display device of the electronic device; transforming the second color code information to display a second color code on a second display region of the display device; and determining whether the cradle device matches the electronic device or not according to the first color code and the second color code.

### CROSS REFERENCE TO RELATED APPLICATIONS

This application is a Continuation-In-Part of application Ser. No. 14/755,309, filed on Jun. 30, 2015. This Application also claims priority of Taiwan Patent Application No. 104142427, filed on Dec. 17, 2015, the entirety of which is incorporated by reference herein.

### BACKGROUND OF THE INVENTION

Field of the Invention

The technical field relates to a device matching verification method, and more particularly to a device matching verification method using color code information.

Description of the Related Art

FIG. 1 is a configuration diagram showing a tablet PC (personal computer) 11 and a cradle device 12. The user can increase the functions of a tablet PC 11 by connecting the tablet PC 11 and cradle device 12. For example, the keyboard device attached to the cradle device 12 may satisfy a person who used to use a keyboard device for keying in data, and the storage device (i.e. a hard disk) attached to the cradle device 12 expanded the data storage capacity of the tablet PC 11. When using multiple groups of tablet PCs 11 and cradle devices 12 (e.g. at a meeting place or an educational facility), a tablet PC 11 and cradle device 12 may lose their match after the user is finished using the tablet PC 11 and cradle device 12. At this time, a supervisor needs a fast and easy way to recognize an originally paired combination of a tablet PC 11 and cradle device 12. In view of this, the present invention provides a device matching verification method for matching tablet PCs 11 and cradle devices 12 and for protecting personal files stored in a cradle device 12.

### BRIEF SUMMARY OF THE INVENTION

A detailed description is given in the following embodiments with reference to the accompanying drawings.

An embodiment of the present invention provides a device matching verification method. The device matching verification method includes reading matching password information used to unlock an external storage device from a basic input/output system of an electronic device; detecting whether the electronic device is connected to the external storage device or not; and using the matching password information to unlock a locked status of the external storage device if detecting that the electronic device is connected to the external storage device and the electronic device is in the locked status.

An embodiment of the present invention provides a device matching verification method. The device matching verification method includes reading matching password information used to unlock a storage device from a basic input/output system of an electronic device; setting the storage device in a locked status when the electronic device enters into a power management period; detecting, during the power management period, whether a human-computer event occurs in the electronic device or not; and using the matching password information to unlock the locked status of the storage device if a human-computer event is detected in the electronic device.

An embodiment of the present invention provides a device matching verification method. The device matching verification method includes reading, respectively, first color code information stored in a cradle device and second color code information stored in a memory device of an electronic device; transforming the first color code information to display a first color code in a first display region of a display device of the electronic device; transforming the second color code information to display a second color code in a second display region of the display device; and determining whether the cradle device matches the electronic device or not according to the first color code and the second color code.

An embodiment of the present invention provides a device matching verification method. The device matching verification method includes reading, respectively, first color code information stored in a cradle device and second color code information stored in a memory device of an electronic device; transforming the first color code information to display a first color code in a first display region of a display device of the electronic device; transforming the second color code information to display a second color code in a second display region of the display device; and determining whether the cradle device matches the electronic device or not according to the first color code and the second color code.

An embodiment of the present invention provides a computer system. The computer system includes a cradle device and an electronic device. The cradle device includes a storage device and a first memory device, wherein the first memory device stores first color code information. The electronic device is connected to cradle device. The electronic device includes a display device, a second memory, a third memory and a processor. The display device has a first display region and a second display region. The second memory device is used to load a basic input/output system. The third memory device is used to store second color code information. The processor is connected to the display device, the first memory device, the second memory device and the third memory device. The processor reads the color code information and the second color code information from the basic input/output system to display a first color code in the first display region and a second color code in the second display region such that a user determines whether the cradle device matches the electronic device or not according to the first color code being equal to the second color code.

### BRIEF DESCRIPTION OF THE DRAWINGS

The present invention can be more fully understood by reading the subsequent detailed description and examples with references made to the accompanying drawings, wherein:

FIG. 1 is a configuration diagram showing a tablet personal computer (PC) 11 and a cradle device 12.

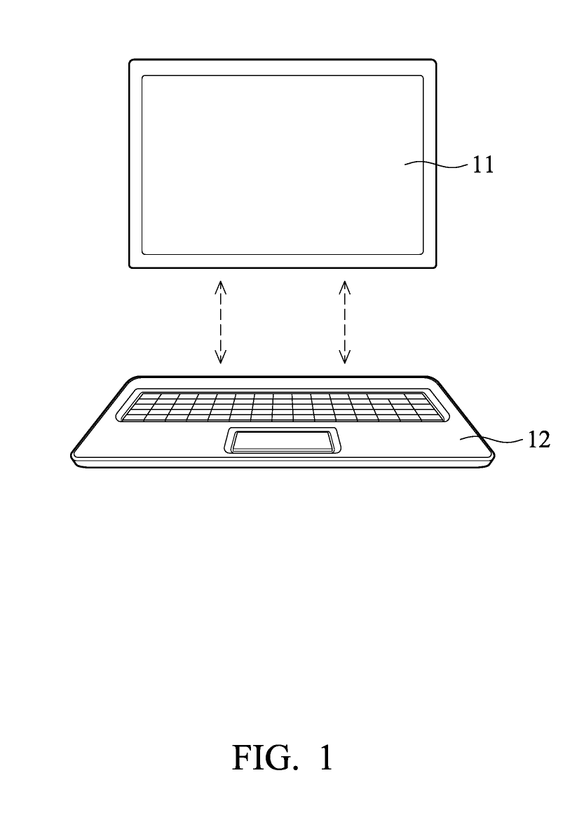

FIG. 2 is a block diagram showing a computer system 20 according to a first embodiment of the present invention.

FIG. 3 shows a flow diagram to illustrate a device matching verification method according to a ninth embodiment of the present invention.

FIG. 4 shows a flow diagram to illustrate a device matching verification method according to a tenth embodiment of the present invention.

FIG. 5 is a block diagram showing a computer system 50 according to an eleventh embodiment of the present invention.

FIGS. 6A, 6B and 6C are diagrams illustrating how to display the first color code and the second color code according to a twelfth embodiment of the present invention.

FIG. 7 shows a flow diagram to illustrate a device matching verification method according to a thirteenth embodiment of the present invention.

### DETAILED DESCRIPTION OF THE INVENTION

The following description is of the best-contemplated mode of carrying out the present disclosure. This description is made for the purpose of illustrating the general principles of the present disclosure and should not be taken in a limiting sense. The scope of the present disclosure is best determined by reference to the appended claims.

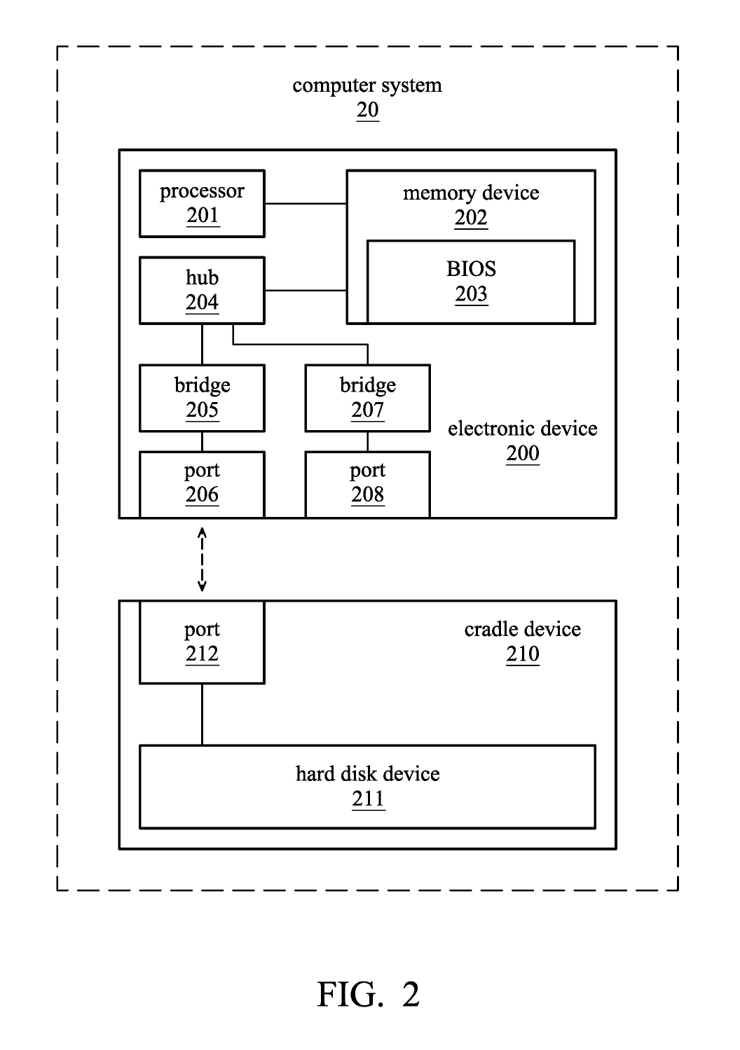

FIG. 2 is a block diagram showing a computer system 20 according to a first embodiment of the present invention. In the first embodiment, the computer system 20 comprises an electronic device 200 and a cradle device 210. The electronic device 200 comprises a processor 201, a memory device 202, a Basic Input/Output System (BIOS) 203, a hub 204, a bridge 205, a bridge 207, a port 206, and a port 208. The cradle device 210 comprises a hard disk device 211 and a port 212. The processor 201 respectively connects to the memory device 202 and the hub 204. The bridge 205 is used to connect the hub 204 with the port 206, and the bridge 207 is used to connect the hub 204 with the port 208. The hard disk device 211 is connected to the port 212.

In the first embodiment, the electronic device 200 is a tablet PC, the memory device 202 is a serial peripheral interface (SPI) read only memory (ROM), and the bridges 205 and 207 adopt universal serial bus (USB) serial advanced technology attachment (SATA). In the first embodiment, the port 206, 208 and 212 are the connection ports adopted the USB interface, and the hard disk device 211 is a SATA hard disk device which supports USB interface. However the present invention is not limited thereto. For example, the electronic device 200 also can be any computer device equipped with an operating system, the memory device 202 can be any other memory device which can load the BIOS 203, and the hard disk device 211 can be any other external storage which supports the transmission interface of the port 206, 208 and 212.

In the first embodiment, the memory device 202 is used to equip with the BIOS 203, wherein the BIOS 203 stores matching password information used to unlock hard disk device 211. The BIOS 203 is equipped in the memory device 202. The BIOS 203 is a bridge used for communication between the firmware and hardware of the electronic device 200. After the electronic device 200 starts, the processor 201 first performs the BIOS 203 to initialize the hardware of the electronic device 200. Performing the BIOS 203 establishes memory-mapped graphics and thus leads the software environment of the electronic device 200 into a suitable status. In other words, the processor 201, by performing the BIOS 203, leads the electronic device 200 to correctly start the operating system stored in the electronic device 200. The processor 201 detects whether the electronic device 200 is connected to the hard disk device 211 or not. After the electronic device 200 starts, the processor 201 reads the matching password information from the BIOS 203. If the processor 201 detects the electronic device 200 is connected to the hard disk device 211 and detects the hard disk device 211 is in a locked status, the processor 201 uses the matching password information to unlock the locked status of the hard disk device 211.

In the first embodiment, in cases where the computer system 20 supports Selective Suspend of power management, the processor 201 further detects whether a human-computer event occurs in the computer system 20 or not. For example, the processor 201 detects whether there is a keyboard input from the cradle device 210, or it detects whether the user is touching a screen of the electronic device 200 or not. When the processor 201 detects that the human-computer event is occurring in the computer system 20, the processor 201 reads the matching password information from the BIOS 203 and uses the matching password information to unlock the locked status of the hard disk device 211.

A second embodiment of the present invention illustrates how to set the matching password information of the computer system 20. In the second embodiment, electronic device 200 is connected to port 212 of cradle device 210 through port 206, and then the user turns on the electronic device 200 to begin running an operating system. Then the user selects and performs an application program of the operating system to start a password protection of the computer system 20 for generating a matching relationship between the electronic device 200 and the cradle device 210. In the second embodiment, the processor 201 performs the application program to inquire about whether to set the matching password information or not, to the BIOS 203. The BIOS 203 accesses the memory device 202 to verify whether the matching password information is stored in the memory device 202 or not. If the BIOS 203 cannot read the matching password information, then the BIOS 203 informs the processor 201 that the computer system 20 is not protected by the matching password information. At this time, the processor 201 performs the application program to generate random first matching password information for encrypting the hard disk device 211 such that the hard disk device 211 can recognize the first matching password information. Meanwhile, the processor 201 transmits the first matching password information to the BIOS 203 to let the BIOS 203 store the first matching password information in the memory device 202 (i.e. stored in the BIOS 203). The BIOS 203 informs the processor 201 when the BIOS 203 finishes the storage step. Finally, after the processor 201 finishes the above steps, the processor 201 asks the user whether to restart the electronic device 200 for enabling the first matching password information or not.

A third embodiment of the present invention illustrates how the electronic device 200 uses the first matching password information to unlock the hard disk device 211 of the cradle device 210. In the third embodiment, the electronic device 200 is already connected to the port 212 of the cradle device 210 through the port 206. Then the user turns on the electronic device 200 to begin running an operating system. After the electronic device 200 has begun running the operating system, the processor 201 asks the BIOS 203 for the first matching password information. The BIOS 203 reads the first matching password information and sends the first matching password information to the processor 201. Then the processor 201 detects the electronic device 200 is connected to the hard disk device 211 and detects the hard disk device 211 is in the locked status. Finally, the processor 201 uses the first matching password information to unlock the locked status of the hard disk device 211. Through the above method of the third embodiment, the electronic device 200 can actively processes and finish the operation of unlocking the hard disk device 211 without asking the user.

A fourth embodiment of the present invention illustrates how the electronic device 200 uses the first matching password information to unlock the hard disk device 211 of the cradle device 210. In the fourth embodiment, the electronic device 200 has already turned on and begun running the operating system, and the electronic device 200 does not connect to the cradle device 210. At this time, the processor 201 actively asks the BIOS 203 for the first matching password information. The BIOS 203 reads the first matching password information and sends the first matching password information to the processor 201. Then, in the fourth embodiment, the user connects the electronic device 200 to the hard disk device through the port 212. The BIOS 203 receives a connection signal from the cradle device 210 and reports the connection signal to the processor 201. At this time, the processor detects the BIOS 203 to know that the electronic device 200 is already connected to the cradle device 210 and detects hard disk device 211 is in the locked status. Finally, processor 201 uses the first matching password information to unlock the locked status of the hard disk device 211. Through the above method of the fourth embodiment, the electronic device 200 can actively process and finish the operation of unlocking the hard disk device 211 without asking the user.

A fifth embodiment of the present invention illustrates how the electronic device 200 uses the first matching password information to unlock the hard disk device 211 of the cradle device 210. In the fifth embodiment, the electronic device 200 has already turned on and the electronic device 200 is in a sleeping mode or a hibernate mode of the operating system. Because the electronic device 200 is in the sleeping mode or the hibernate mode, the hard disk device 211 is in the locked status. When the user operates the electronic device 200 to wake up the electronic device 200 from the sleeping mode or the hibernate mode, the processor 201 actively performs an application program to ask the BIOS 203 for the first matching password information. The BIOS 203 reads the first matching password information and sends the first matching password information to the processor 201. Finally, the processor 201 uses the first matching password information to unlock the locked status of the hard disk device 211. Through the above method of the fifth embodiment, the electronic device 200 can actively process and finish the operation of unlocking the hard disk device 211 without asking the user when the electronic device 200 is woken up from the sleeping mode or the hibernate mode.

A sixth embodiment of the present invention illustrates how to remove the matching relationship between the electronic device 200 and the cradle device 210. In the sixth embodiment, the electronic device 200 has already connected to the port 212 of the cradle device 210 through the port 206, and the user has turned on the electronic device 200 to begin running the operating system. Then the user selects and performs an application program of the operating system to remove the matching relationship between the electronic device 200 and the cradle device 210. In the sixth embodiment, the processor 201 performs the application program to ask the BIOS 203 whether to set the matching password information or not. The BIOS 203 reads the memory device 202 to check whether the matching password information is stored in the memory device 202 or not. If yes, the BIOS 203 reports the matching password information to the processor 201. Then the processor 201 informs the BIOS 203 to remove the matching password information and to remove the encrypting setting of the hard disk device 211 through the matching password information. Finally, the BIOS 203 removes the matching password information stored in the memory device 202 and informs the processor 201 that the matching password information has been removed.

A seventh embodiment of the present invention illustrates how to use the BIOS 203 to remove the matching relationship between the electronic device 200 and the cradle device 210. In the seventh embodiment, the electronic device 200 has already connected to the port 212 of the cradle device 210 through the port 206. In the seventh embodiment, the user has turned on the electronic device 200, but the electronic device 200 does not begin running the operating system. At this time, the user operates electronic device 200 to enter into the BIOS 203 (for example, the user presses the F2 button to enter into the BIOS 203). In the BIOS 203, the user switches to the safety page to display a setting status of matching password information. Then the user starts to remove the procedure of removing the matching password information through the way of selecting the setup menu. In the seventh embodiment, the user performs a program of reverse password to obtain a master password, uses the master password and the matching password information to remove the encrypting setting of the hard disk device 211, and clears the matching password information stored in the memory device 202. In the seventh embodiment, the user dos not need to begin running the operating system to remove the matching relationship between the electronic device 200 and the cradle device 210. In other words, the user can remove the matching relationship between the electronic device 200 and the cradle device 210 through the method disclosed in the seventh embodiment when the electronic device 200 cannot activate the operating system, cannot switch to another operating system or cannot use the application program disclosed in the fifth embodiment.

The above methods disclosed in the second embodiment to the seventh embodiment can increase the matching relationship between the electronic device 200 and the cradle device 210 without increasing the cost of the hardware. Furthermore, the device matching verification method of the second embodiment to the fourth embodiment can avoid the hard disk device 211 of the cradle device 210 being easily accessed. In addition, the unlock operations in the third embodiment to the fifth embodiment are all automatic. Thus the hard disk device 211 always protected. Even if the hardware of the electronic device 200 is broken or the operating system of the electronic device 200 breaks down, the user still has the opportunity to remove the encrypting setting of the hard disk device 211 and access the data stored in the hard disk device 211 using the method disclosed in the seventh embodiment.

Because the interface of the port 206, the port 208 and the port 212 is a USB interface, the electronic device 200 can support Selective Suspend of the power management to reduce the power consumption of USB devices. When the electronic device 200 begins running the operating system to perform a Selective Suspend power management program, the hard disk device 211 will be locked due to entering in a preset power management period. At this time, the user is not convenient to directly access the hard disk device 211. For a WINDOWS operating system, solving the above problem requires that the USB controller be commanded to stop performing the Selective Suspend power management program. As a result, the electronic device 200 cannot simultaneously perform the Selective Suspend power management program and access the hard disk device 211. There exist a conflict between the Selective Suspend and accessing the disk device 211.

An eighth embodiment of the present invention illustrates how to keep the matching relationship between the electronic device 200 and the cradle device 210 when the electronic device 200 is supporting Selective Suspend of the power management. In the eighth embodiment, during a power management period, the processor 201 detects, during a power management period, whether a human-computer event occurs in the electronic device 200 or not. For example, the processor 201 detects a keyboard input which is from the cradle device 210, or detects whether the user touches a screen of the electronic device 200 or not. When the processor 201 detects that the human-computer event is occurring in the computer system 20, the processor 201 reads the matching password information from the BIOS 203 and uses the matching password information to unlock the locked status of the hard disk device 211. At this time, the hard disk device 211 is not in the locked status during the power management period such that the processor 201 does not need to perform the detecting and unlocking operations. In other words, if the processor 201 has unlocked the locked status of the hard disk device 211, the processor 201 stops detecting the human-computer event until the electronic device 200 enters into the next power management period. The time requiring in the above unlocking operation should be less than a predetermined time (for example, 1.5 second) such that the electronic device 200 can make a balance between “the Selective Suspend status has been stopped in advance” and “cannot directly access the hard disk device 211”. When the electronic device 200 enters into the next power management period, the electronic device 200 performs the Selective Suspend power management program to set the hard disk device 211 in the locked status. Through the method disclosed in the eighth embodiment, the user can operate the computer system 20 to access the hard disk device 211 when the electronic device 200 is performing the Selective Suspend power management program.

A ninth embodiment of the present invention illustrates the electronic device 200 how to recognize which the hard disk device 211 should be locked. In the ninth embodiment, the bridge 205 and the bridge 207 are respectively installed in a chip. In the ninth embodiment, the designer of the computer system 20 writes recognition information (for example, a specific string) into a field of a firmware which is loaded in the chip of the bridge 205. The recognition information is used to inform processor 201 for recognizing the port 206 which is used for connecting the cradle device 210. After the computer device 20 is turned on, the processor 201 recognizes whether each of the plurality of bridges (for example, the port 205 and the port 207) has the recognition information or not, and thereby knows which the port used to connect the cradle device 210 (for example, the port 206). In other words, the processor 201 recognizes whether the bridge contains the recognition information or not. If the processor 201 recognizes the bridge which contains the recognition information, processor 201 performs the lock/unlock operations on the storage device which is connected to the bridge. Hence the recognition method of the ninth embodiment can selectively protect the data safety of the storage device which is corresponding to a specific bridge. In addition, the recognition method of the ninth embodiment is only required to add the recognition information (for example, a specific string) into a specific field of the firmware or into the name of the bridge without customizing the firmware or incurring other development costs. Through the method disclosed in the ninth embodiment, the processor 201 can automatically recognize the hard disk device 211 of the cradle device 210 from all of USB devices to perform the device matching verification methods disclosed in the second embodiment to the eighth embodiment to the hard disk device 211.

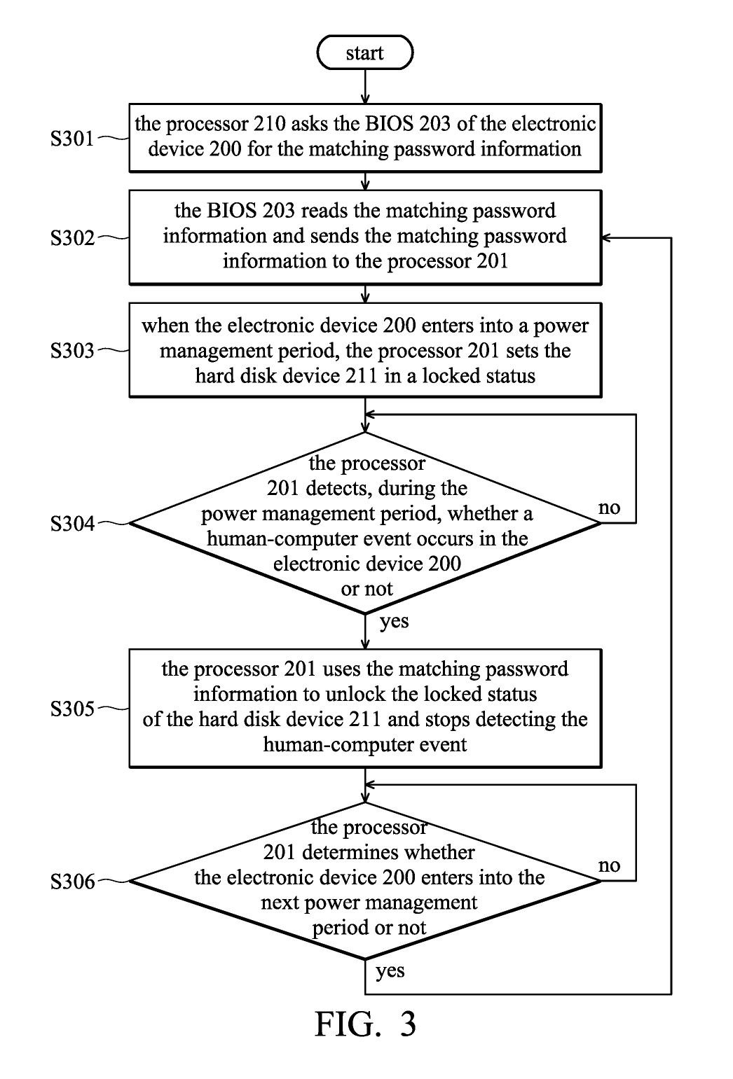

FIG. 3 shows a flow diagram to illustrate a device matching verification method according to a ninth embodiment of the present invention. In step S301, the processor 210 asks the BIOS 203 of the electronic device 200 for the matching password information. In step S302, the BIOS 203 reads the matching password information and sends the matching password information to the processor 201. In step S303, when the electronic device 200 enters into a power management period, the processor 201 sets the hard disk device 211 in a locked status. In step S304, the processor 201 detects, during the power management period, whether a human-computer event occurs in the electronic device 200 or not. If yes, the method proceeds to step S305. In step S305, the processor 201 uses the matching password information to unlock the locked status of the hard disk device 211 and stops detecting the human-computer event. In step S306, the processor 201 determines whether the electronic device 200 enters into the next power management period or not. If yes, the method proceeds back to step S302.

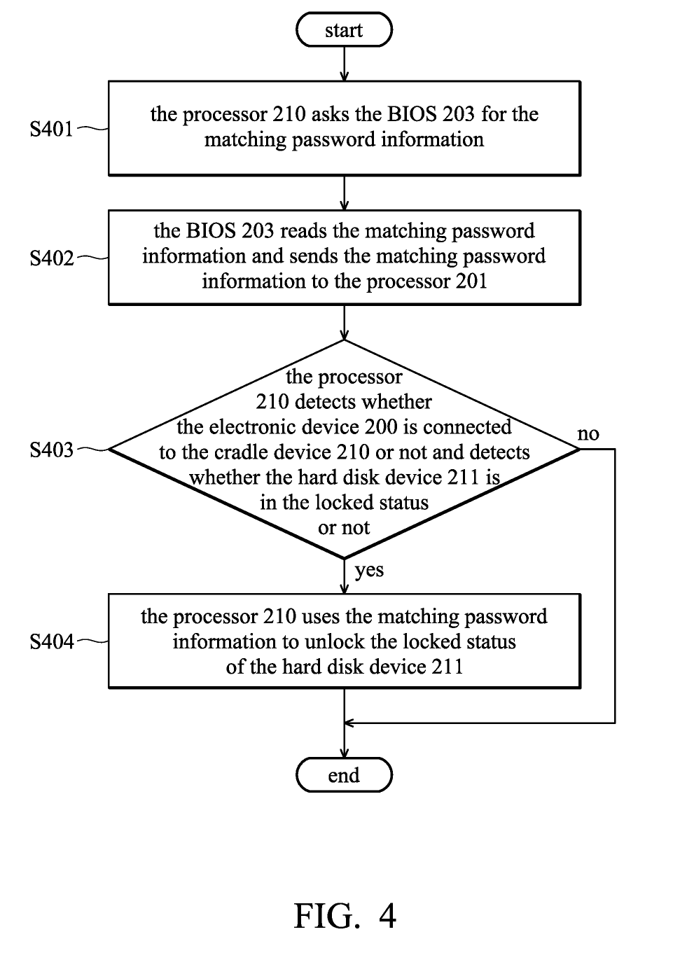

FIG. 4 shows a flow diagram to illustrate a device matching verification method according to a tenth embodiment of the present invention. In step S401, the processor 210 asks the BIOS 203 for the matching password information. In step S402, the BIOS 203 reads the matching password information and sends the matching password information to the processor 201. In step S403, the processor 210 detects whether the electronic device 200 is connected to the cradle device 210 or not and detects whether the hard disk device 211 is in the locked status or not. If yes, the method proceeds to step S404. Finally, in step S404, the processor 210 uses the matching password information to unlock the locked status of the hard disk device 211.

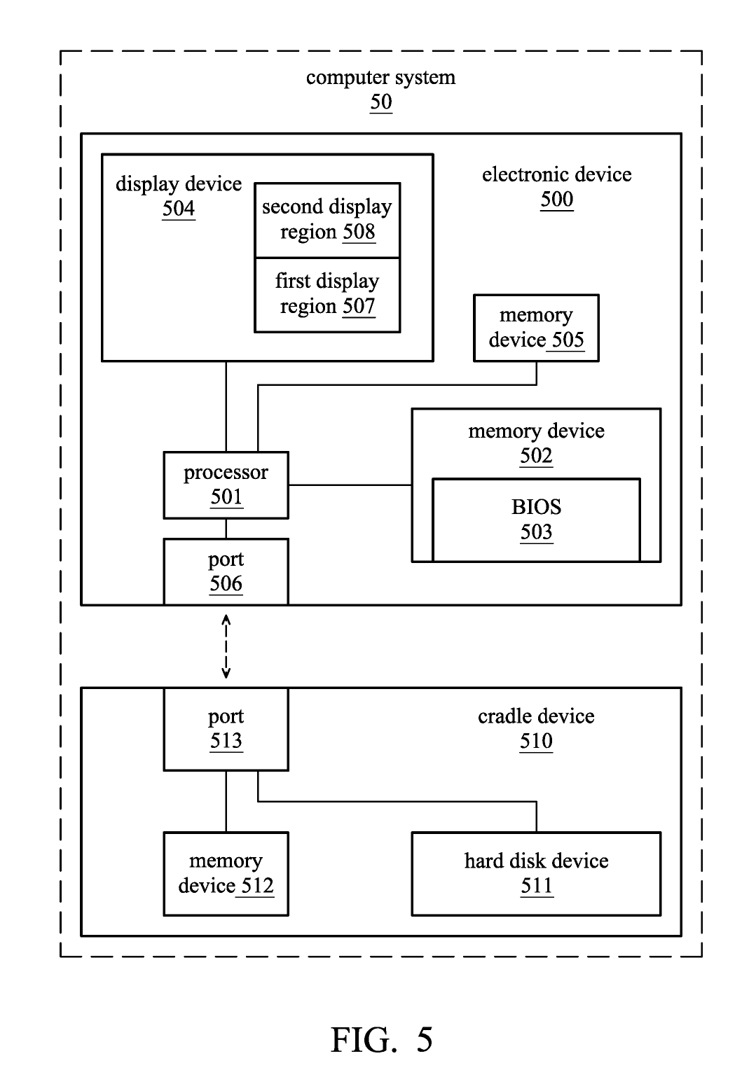

FIG. 5 is a block diagram showing a computer system 50 according to an eleventh embodiment of the present invention. In the eleventh embodiment, the computer system 50 includes an electronic device 500 and a cradle device 510. The electronic device 500 includes a processor 501, a memory device 502, a Basic Input/Output System (BIOS) 503, a display device 504, a memory device 505, and a port 506. The cradle device 510 includes a hard disk device 511, a memory device 512 and a port 513. The electronic device 500 and the cradle device 510 are respectively connected to the port 506 and the port 513. The processor 501 is respectively connected to the memory device 502, the display device 504, the memory device 505 and the port 506. The port 513 is respectively connected to the hard disk device 511 and the memory device 512. The memory device 502 is equipped with the BIOS 503. The memory device 512 of the cradle device 510 stores first color code information and the memory device 505 of the electronic device 500 stores second color code information. The display device 504 has a first display region 507 and a second display region 508.

In the eleventh embodiment, the electronic device 500 is a tablet PC, the memory device 502 is a readable non-volatile memory (e.g. SPI NOR Flash Memory), the display device 504 is a touch screen of the tablet PC, the memory device 505 is a non-volatile memory (e.g. DDR3 SRAM), the port 506 and the port 513 are ports of a USB interface, the hard disk device 513 is a SATA hard disk which supports the USB interface, but the present invention is not limited thereto. E.g. the electronic device 500 can be any computer device equipped with an operating system, the memory device 502 can be any memory device which can be equipped with the BIOS 503, and the hard disk device 511 can be any external hard disk device which supports a transmission interface of the port 506.

In the eleventh embodiment, the processor 501 performs BIOS 503 to read the first color code information and the second color code information, and performs BIOS 503 to display a first color code in the first display region 507 and to display a second color code in the second display region 508 such that a user determines whether cradle device 510 matches the electronic device 500 or not according to the first color code being equal to the second color code.

In the eleventh embodiment, if a user wants to know whether a used tablet PC matches a cradle device or not, the user enters an operation interface of the BIOS 503 to chooses and enable a color matching function. At this time, the BIOS 503 converts the first color code information stored in the memory device 512 of the cradle device 510 into a first color code and displays the first color code in the first display region 507. the BIOS 503 also converts the second color code information stored in the memory device 505 of the electronic device 500 into a second color code and displays the second color code in the second display region 508. Finally, the user can see whether the first color is the same as the second color code or not and determines, according to identical or not, whether the cradle device 510 matches the electronic device 500 or not. In the eleventh embodiment, the first color code information and the second color code information can be hash values, each of the first color code and the second color code can be an identifier plus a background color display in the first display region 507 or the second display region 508.

In the eleventh embodiment, when the user enables the color matching function, the processor performs the BIOS 503 to detect whether the port 506 of electronic device 500 has been reseated or not. If the BIOS 503 detects that port 506 of electronic device 500 has been reseated, the processor performs the BIOS 503 to read the first color code information stored in the memory device 512 of the cradle device 510 being connected to the electronic device 500. At this time, the processor 501 converts the newly read first color code information into a new first color code and displays the new first color code in the first display region 507. Therefore the user can quickly find a specific cradle device 510 matched to electronic device 500 in a plurality of cradle devices 510 by enabling the color matching function.

In other words, in the eleventh embodiment, if the user would confirm whether his tablet PC (the electronic device 500) matches a dock (the cradle device 510) being connected to his tablet PC or not, the user operates his tablet PC to enter a setup menu if the BIOS 503. At this time, the BIOS 503 reads an identifier (the second color code information) of the tablet PC and simultaneously reads an identifier (the first color code information) of the dock. Then the BIOS 503 converts the two identifiers into two color codes and represents the two colors by two colored rectangular for comparing the first color code and the second color code. Therefore a device matching verification method disclosed in the eleventh embodiment provides the user easy ways of identification and matching by comparison of colors.

In the eleventh embodiment, the device matching verification method further includes automatically matching the tablet PC (the electronic device 500) and the dock (the cradle device 510) which are connected while first booting. E.g. when the tablet PC and the dock boot in the first time and the memory device 502 of the tablet PC does not have the identifier, the BIOS 503 automatically sets a set of color code information and respectively stores the color code information into the memory device 512 of cradle device 510 and the memory device 502 of the electronic device 500.

In addition, it is noticeable that the device matching verification methods and the computer system disclosed in the first embodiment to the tenth embodiment of the present invention also can be applied into the computer system 50 disclosed in the eleventh embodiment of the present invention. Hence, in the eleventh embodiment, if the first color code matches the second color code and the processor 501 detects (or the processor 501 performs the BIOS 503 to detect) the hard disk device 510 of the cradle device 510 is in a locked status, the processor 501 reads matching password information for unlocking the cradle device 510 (or the hard disk device 510) from the BIOS 503 and uses the matching password information to unlock the locked status of the cradle device 510 (or the hard disk device 510). According to the above embodiments, the matching password information of the device matching verification methods and the computer system disclosed in the first embodiment to the tenth embodiment can be coded or directly used as the color code information for determining whether the electronic device is matched or not. And the color code information of the eleventh embodiment of the present invention also can be coded or directly used as matching password information for unlocking the locked status of a system or a storage device. In the eleventh embodiment, when the processor 501 sets the cradle device 510 (or the hard disk device 510) in the locked status when the electronic device 500 enters into a power management period. During the power management period, the processor 501 detects whether a human-computer event occurs in the electronic device 500 or not. If the human-computer event is detected in the electronic device 500, the processor 501 uses the matching password information to unlock the locked status of the cradle device 510 (or the hard disk device 510).

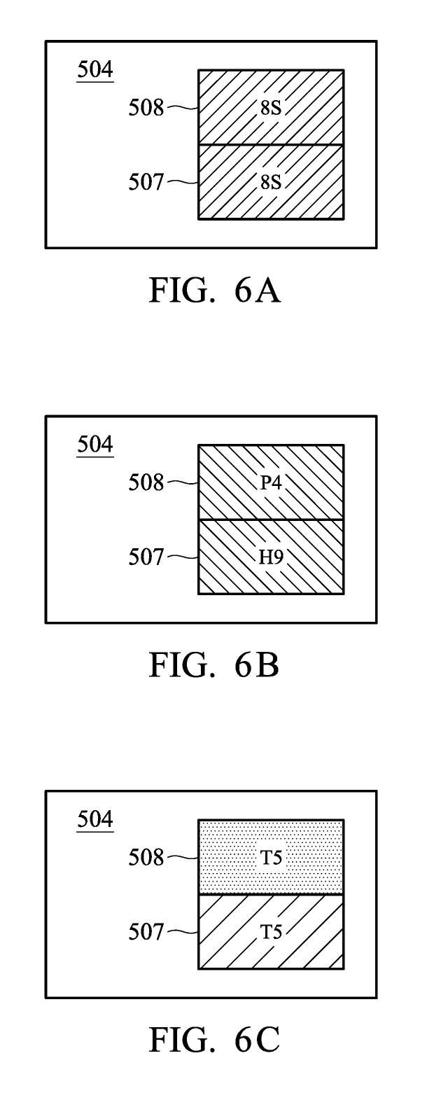

FIGS. 6A, 6B and 6C are diagrams illustrating how to display the first color code and the second color code according to a twelfth embodiment of the present invention. In the twelfth embodiment, in order to avoid misjudgment in similar colors, each of the two colored rectangular (i.e. first display region 507 and second display region 508) is respectively placed an identifier for recognition, the color and the identifier displayed corresponding to one color code information is fixed. In the twelfth embodiment, as shown in FIG. 6A, the background color of first display region 507 is identical to the background color of second display region 508, and the identifier (8S) of first display region 507 is also identical to the identifier (8S) of second display region 508. Therefore the user knows the electronic device 500 matches the cradle device 510 being connected to electronic device 500 according to a display situation shown in FIG. 6A. In the twelfth embodiment, as shown in FIG. 6B, the background color of first display region 507 is identical to the background color of second display region 508, but the identifier (H9) of first display region 507 is different from the identifier (P4) of second display region 508. In the twelfth embodiment, as shown in FIG. 6C, the identifier (T5) of first display region 507 is identical to the identifier (T5) of second display region 508, but the background color of first display region 507 is different from the background color of second display region 508. Therefore the user knows that electronic device 500 does not match the cradle device 510 being connected to the electronic device 500 according to display situations shown in FIG. 6B and FIG. 6C. In addition, the twelfth embodiment also includes only displaying the background colors in first display region 507 and second display region 508 or only displaying the identifiers in first display region 507 and second display region 508.

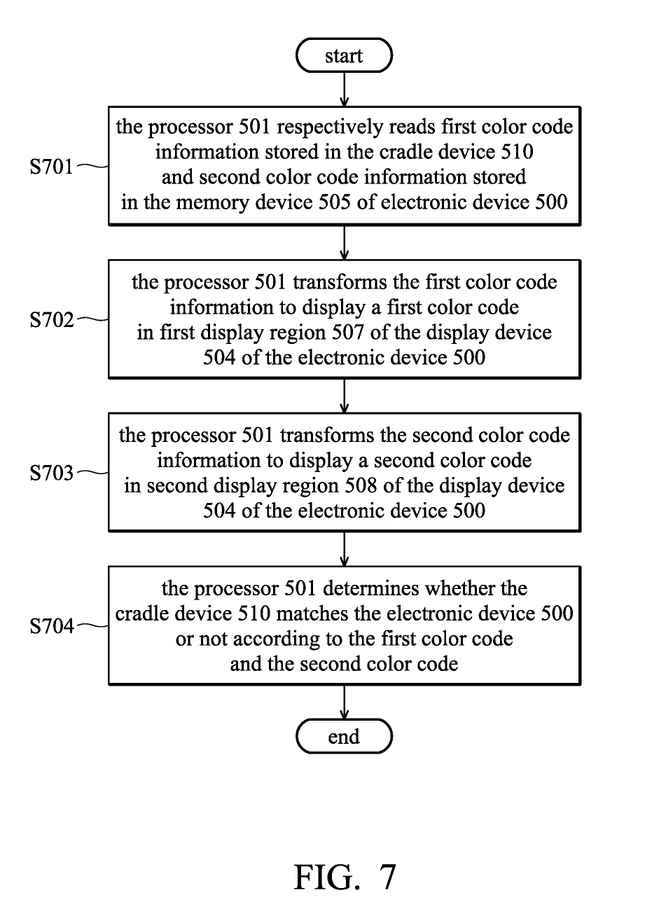

FIG. 7 shows a flow diagram to illustrate a device matching verification method according to a thirteenth embodiment of the present invention. In step S701, the processor 501 respectively reads first color code information stored in the cradle device 510 and second color code information stored in the memory device 505 of electronic device 500. In step S702, the processor 501 transforms the first color code information to display a first color code in first display region 507 of the display device 504 of the electronic device 500. In step S703, the processor 501 transforms the second color code information to display a second color code in second display region 508 of the display device 504 of the electronic device 500. Finally, in step S704, the processor 501 determines whether the cradle device 510 matches the electronic device 500 or not according to the first color code and the second color code.

While the present disclosure has been described by way of example and in terms of preferred embodiment, it should be understood that the present disclosure is not limited thereto. On the contrary, it is intended to cover various modifications and similar arrangements (as would be apparent to a person skilled in the art). Therefore, the scope of the appended claims should be accorded the broadest interpretation so as to encompass all such modifications and similar arrangements.

Also, although the disclosure has been shown and described with respect to one or more implementations, equivalent alterations and modifications will occur to others skilled in the art based upon a reading and understanding of this specification and the annexed drawings. The disclosure comprises all such modifications and alterations and is limited only by the scope of the following claims. In particular regard to the various functions performed by the components described above (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A device matching verification method, comprising:
reading matching password information used to unlock an external storage device from a basic input/output system of an electronic device;
detecting whether the electronic device is connected to the external storage device or not; and
using the matching password information to unlock a locked status of the external storage device if detecting that the electronic device is connected to the external storage device and the electronic device is in the locked status.

2. The device matching verification method of claim 1, further comprising:
reading the matching password information from the basic input/output system after the electronic device starts up and begins running an operating system.

3. The device matching verification method of claim 1, wherein the matching password information is used to match the external storage device and the electronic device.

4. The device matching verification method claim 1, further comprising:
removing the matching password information by the basic input/output system when the electronic device has started up and has not begun running an operating system.

5. A device matching verification method, comprising:
reading matching password information used to unlock a storage device from a basic input/output system of an electronic device;
setting the storage device in a locked status when the electronic device enters into a power management period;
detecting, during the power management period, whether a human-computer event occurs in the electronic device or not; and
using the matching password information to unlock the locked status of the storage device if the human-computer event is detected in the electronic device.

6. The device matching verification method of claim 5, further comprising:
stopping detection of the human-computer event until the electronic device enters into the next power management period when the locked status of the storage device is unlocked.

7. The device matching verification method of claim 6, further comprising setting the storage device in the locked status when the electronic device enters into the next power management period.

8. The device matching verification method of claim 5, further comprising:
reading the matching password information from the basic input/output system after the electronic device starts up and begins running an operating system.

9. The device matching verification method of claim 5, wherein the matching password information is used to match the electronic device and the storage device.

10. The device matching verification method of claim 5, further comprising:
reading the matching password information from the basic input/output system and using the matching password information to unlock the locked status of the storage device after the electronic device is woken up from a sleeping mode or a hibernate mode.

11. The device matching verification method of claim 5, further comprising:
recognizing whether a bridge contains recognition information or not; and
performing the locking and unlocking operations to a storage device connected to the bridge if the bridge contains the recognition information.

12. A device matching verification method, comprising:
reading, respectively, first color code information stored in a cradle device and second color code information stored in a memory device of an electronic device;
transforming the first color code information to display a first color code in a first display region of a display device of the electronic device;
transforming the second color code information to display a second color code in a second display region of the display device; and
determining whether the cradle device matches the electronic device or not according to the first color code and the second color code.

13. The device matching verification method of claim 12, further comprising reading the matching password information from the basic input/output system and using the matching password information to unlock the locked status of the storage device if the first color code and the second color code are matched.

14. The device matching verification method of claim 13, further comprising:
setting the cradle device in a locked status when the electronic device enters into a power management period;
detecting, during the power management period, whether a human-computer event occurs in the electronic device or not; and
using the matching password information to unlock the locked status of the cradle device if the human-computer event is detected in the electronic device.

15. The device matching verification method of claim 13, wherein the matching password information is used to match the external storage device and the electronic device.

16. The device matching verification method of claim 15, further comprising:
reading the matching password information from the basic input/output system and using the matching password information to unlock the locked status of the cradle device after the electronic device is woken up from a sleeping mode or a hibernate mode.

17. A computer system, comprising:
a cradle device, comprising a storage device and a first memory device, wherein the first memory device stores first color code information; and
an electronic device connected to cradle device, wherein the electronic device comprises:
a display device having a first display region and a second display region;
a second memory device used to load a basic input/output system;
a third memory device used to store second color code information; and
a processor, connected to the display device, the first memory device, the second memory device and the third memory device, wherein the processor performs the basic input/output system to read the color code information and the second color code information and performs the basic input/output system to display a first color code in the first display region and to display a second color code in the second display region such that a user determines whether the cradle device matches the electronic device or not according to the first color code being equal to the second color code.

18. The computer system of claim 17, wherein the basic input/output system further stores matching password information for unlocking the storage device; and
wherein when the processor performs the basic input/output system to detect the storage device being in a locked status and the first color code matches the second color code, the processor uses the matching password information to unlock the storage device.

19. The computer system of claim 18, wherein the processor sets the cradle device in a locked status when the electronic device enters into a power management period;
wherein the processor detects, during the power management period, whether a human-computer event occurs in the electronic device or not; and
wherein the processor uses the matching password information to unlock the locked status of the cradle device if the processor detects the human-computer event occurs in the electronic device.

20. The computer system of claim 18, wherein the matching password information is used to match the external storage device and the electronic device.

21. The computer system of claim 18, further comprising the processor reads the matching password information from the basic input/output system and uses the matching password information to unlock the locked status of the storage device after the electronic device is woken up from a sleeping mode or a hibernate mode.
